(19) United States
(12) Patent Application Publication
(10) Pub. No.: US 2026/0080022 A1
(43) Pub. Date: Mar. 19, 2026

(54) DYNAMIC TRUST CONNECTION SIGNAL

(71) Applicant: Peter L. Rex, Bellevue, WA (US)

(72) Inventor: Peter L. Rex, Bellevue, WA (US)

(21) Appl. No.: 18/888,679

(22) Filed: Sep. 18, 2024

(51) Int. Cl. G06F 16/9535

(52) U.S. Cl. CPC G06F 16/9535

(57) ABSTRACT

At least one computer-readable medium on which are stored instructions that, when executed by one or more processing devices, enable the one or more processing devices to perform a method. The method includes the steps of accessing over a network a first user device, accessing over the network second electronic data characterizing a second entity and generated by a second user device, the second electronic data being accessible to the first user device, parsing the second electronic data, determining from the parsed second electronic data that the second entity has a relationship with a third entity, and notifying the first entity of the relationship between the second and third entities.

### PRIORITY CLAIM

This application is a Continuation of U.S. patent application Ser. No. 17/353,562 filed Jun. 21, 2021, which application claims priority from U.S. Provisional Patent Application Ser. No. 63/041,554 filed Jun. 19, 2020, the entirety of which is hereby incorporated by reference as if fully set forth herein.

### BACKGROUND

Currently there are ways of displaying possible connections and making them searchable. For example, LinkedIn uses a system describing 1st, 2nd, and 3rd degree connections based on the number of direct connections separating two users. This method is limited to displaying only data input directly by a user accepting an invitation to connect with another user. It is easily manipulated by anyone wanting the appearance of massive connectivity.

### DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented; and

FIGS. 3-4 schematically illustrate operation of one or more embodiments of the invention.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by a computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media. In some embodiments, portions of the described functionality may be implemented using storage devices, network devices, or special-purpose computer systems, in addition to or instead of being implemented using general-purpose computer systems. The term “computing device,” as used herein, refers to at least all these types of devices, and is not limited to these types of devices and can be used to implement or otherwise perform practical applications.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

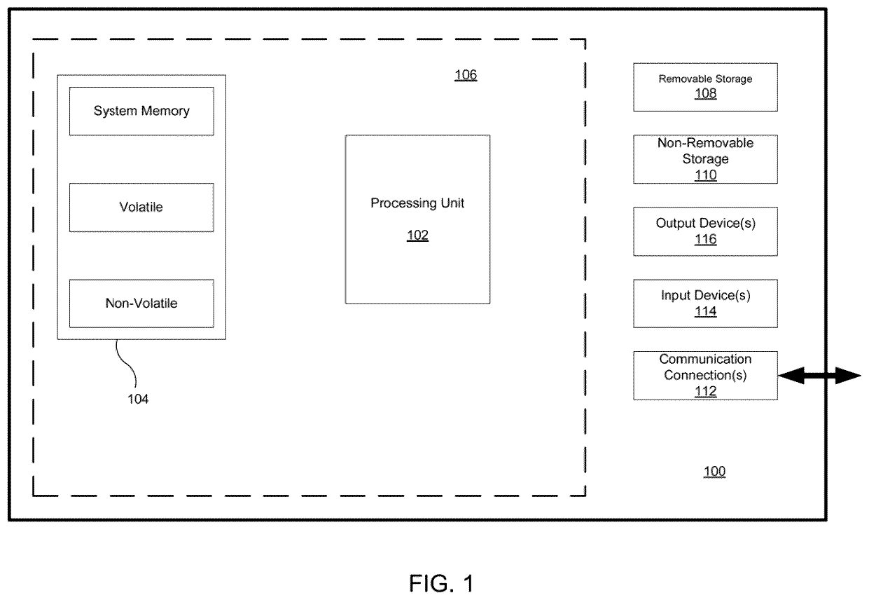

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

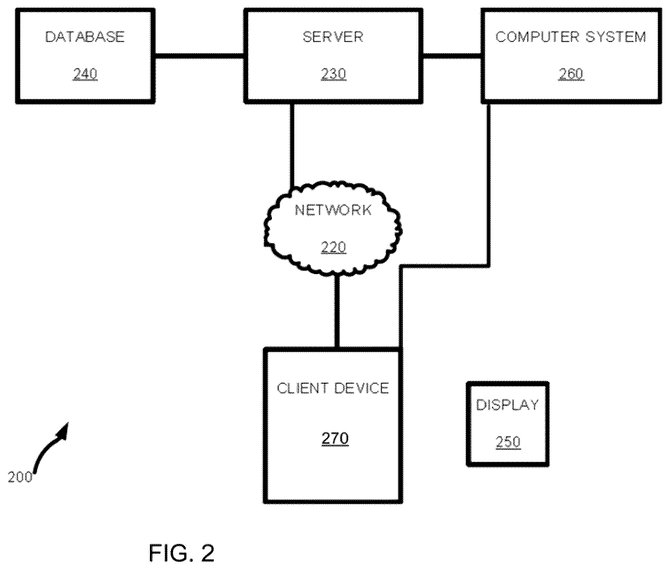

Referring now to FIG. 2, an embodiment of the present invention may take the form, and/or may be implemented using one or more elements, of an exemplary computer network system 200 that, in an embodiment, includes a server 230, database 240 and computer system 260. The system 200 may communicate with an electronic client device 270, such as a personal computer or workstation, tablet or smartphone, that is linked via a communication medium, such as a network 220 (e.g., the Internet), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network-and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. The data stored in database 240 may include, for example, information identifying customers, goods/services previously requested by such customers and providers of those goods/services. Additionally, the server 230 may be coupled to the computer system 260 in a manner allowing the server to delegate certain processing functions to the computer system. In an embodiment, server 230 and/or computer system 260 may be configured to generate and deploy over network 220 crawling devices capable of parsing electronic content including metadata that is distributed or otherwise made available by one or more client devices 270. In an embodiment, most or all of the functionality described herein may be implemented in a desktop or smartphone application that may include one or more executable modules. In an embodiment, the client device 270 may bypass network 220 and communicate directly with computer system 260.

In an embodiment of the invention, using network data of individuals and groups, data from payments to and from different counterparties, local activity data captured on a system via a mobile phone, and online information, the strength of connectivity between two people can be intuited better than is currently available (e.g., LinkedIn 1st level or 2nd level or 3rd level connection) and suggest possible linkages connecting people via “warmly” connected people. An embodiment of the invention enables one to know based on probabilities rather than linear disclosed relationship knowledge (e.g., LinkedIn) if there is a strong or weak connection with someone. Often, the connection may be strong yet one would not know it. Using algorithms and a variety of sources of data, a much truer level of connection can be ascertained and potential connectors may be suggested linking the people.

One or more embodiments may employ the following technologies: mobile phones, smart algorithms, machine learning, massive data storage, payment data sources and location data.

In a system 200 according to an embodiment, which, as above alluded to, may include a processing device and a memory, the connectivity between two people on a social network platform is graded in a manner mimicking signal strength. Using data, algorithms, and probability-based analysis, the system 200 assigns a grade to the level of connectivity between any two people using the platform. This enables a provider of social network information to make recommendations to users seeking introductions to other users sharing specific affiliations, occupations, or interests.

An embodiment is distinguished by its ability to assign an accurate grade to a connection based on a multitude of data entries. It also is difficult to manipulate due to its ability to place weights on the authenticity of connections. The system can identify and recommend users who are likely warm connections, thereby minimizing the possibility of a person being oblivious to a would-be warm connection in their network. It can also recommend users who are more than one network node removed but who are nonetheless warm introductions.

An embodiment includes a network grade assigned to the relationship between two people and used to provide a recommendation on whether they should be introduced to one another. A method of probability-based analysis may be used to determine whether or not two users have any warm connectivity between one another. Additionally, the system offers the ability to recommend sources of connectivity including possible mutual affiliation with organizations, schools, or other entities even in instances where such data is not directly provided by the user. Smart algorithms assign weighted values to connections based on inferred authenticity that can allow the system to assign more accurate network grades to connections.

One or more embodiments may offer the following advantages:

The ability to identify warm connections who might not show up on another social network platform due to users not proactively connecting with each other or with mutual friends.

The ability to see an accurate grade of how closely a person is connected.

Relative inability of a user to game the system by blasting out massive number of connection requests to create an illusion of real-world connectivity.

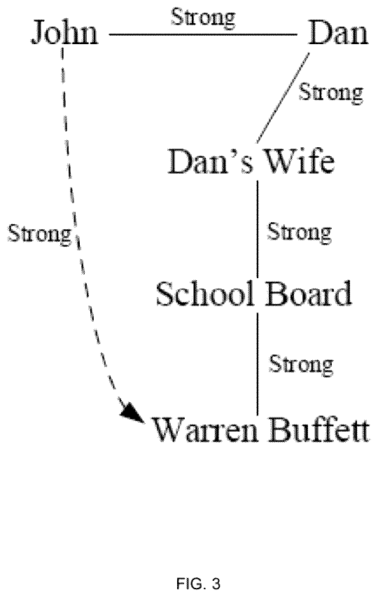

For example, and referring to FIG. 3, a person (“John”) has a friend (“Dan”) whose wife serves on a board along with a person (“Warren Buffett”) with whom John would like to establish a connection. More specifically, John and Dan have been best friends for 15 years and their families are very close. John knows Dan's wife well also, and, consequently, John and Dan's wife have one or more relationships defined by one or more social media platforms. By virtue of, for example, these social media platforms, system 200 is configured to inform John that Dan's wife serves on four different organizational boards. Serving on one of the boards (“School Board”) is Warren Buffett to whom John would like to be introduced. Although John may not realize that Dan's wife, by virtue of her common board membership with Mr. Buffett, is now a warm connection and a friend with Mr. Buffett, an embodiment can reveal to John that, by virtue of John's relationship with Dan's wife, Mr. Buffett likely has a strongly trusted connection with John. Besides using the aforementioned social media platforms, John may use system 200 to “crawl” electronic communications, such as email, SMS messages, photographs, payments/transactions, financial records, etc. that Dan's wife makes available to John and that indicate her relationship with Mr. Buffett. In this manner, John may likewise discover the possibility that Mr. Buffett has a strongly trusted connection with him.

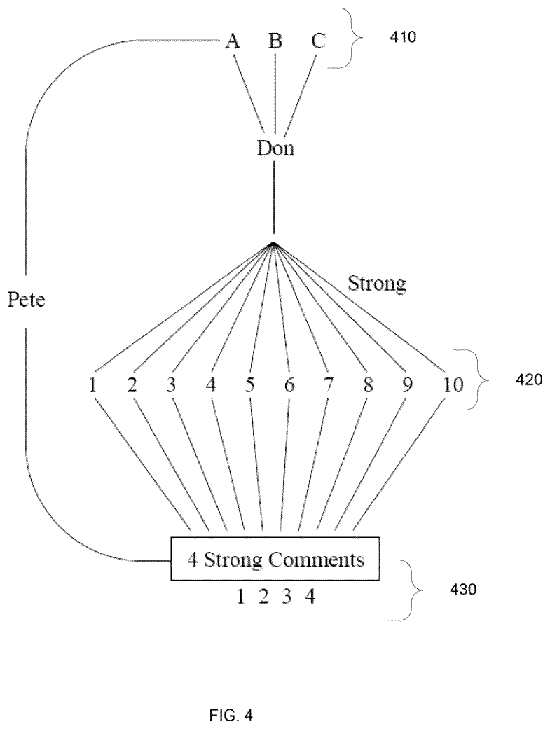

For further example, and referring to FIG. 4, a sought-after connection is very strongly in your network, and it's highly likely you know someone who knows them, yet you don't even realize they're in your network. More specifically, Pete is seeking a Boston investor, Don, who is a billionaire. An embodiment of system 200, using one or more techniques described above herein, discovers data indicating that Don has had financial transactions with three of Pete's friends 410 (i.e., A, B and C) and/or has indicated that he is friends with 10 different people 420 who are known by system 200 to be close friends with four of Pete's friends 430 (i.e., 1, 2, 3 and 4). System 200 further discovers that all 10, plus Don, live within a 10-minute drive of one another. System 200 may assume, based on millions of people, that such a strong connection indicates a very high level of network connectivity compared to an average person. As such, system 200 indicates the likelihood of very-strong signal strength between Pete and Don and can perhaps suggest people who seem likely to have a direct link (i.e., likely one or more of the four directly known friends of Pete are connected directly to Don). Additionally, the system 200 may suggest another likely source of the strength of network connection being shared membership or affiliation with an organization like Knights of Columbus in Harvard Square in Boston.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. A method performed using a processing device, the method comprising
accessing over a network a first user device associated with a first entity;
accessing over the network electronic data characterizing a second entity and generated by a second user device, the second electronic data being accessible to the first user device;
parsing the electronic data;
determining from the parsed electronic data that the second entity has a relationship with a third entity;
assigning a grade to the relationship between the second entity and the third entity; and
based on the grade, notifying the first entity of the relationship between the second and third entities.

2. The method of claim 1, wherein the electronic data comprises data stored on a social media platform.

3. The method of claim 1, wherein the electronic data comprises electronic mail.

4. The method of claim 1, wherein the electronic data comprises one or more short message service messages.

5. The method of claim 1, wherein the electronic data comprises digital photographs.

6. The method of claim 1, wherein the electronic data comprises electronic financial records.

7. A system comprising:
a processing device configured to:
access over a network a first user device associated with a first entity;
access over the network electronic data characterizing a second entity and generated by a second user device, the second electronic data being accessible to the first user device;
parse the electronic data;
determine from the parsed electronic data that the second entity has a relationship with a third entity;
assign a grade to the relationship between the second entity and the third entity; and
based on the grade, notify the first entity of the relationship between the second and third entities.

8. The system of claim 7, wherein the electronic data comprises data stored on a social media platform.

9. The system of claim 7, wherein the electronic data comprises electronic mail.

10. The system of claim 7, wherein the electronic data comprises one or more short message service messages.

11. The system of claim 7, wherein the electronic data comprises digital photographs.

12. The system of claim 7, wherein the electronic data comprises electronic financial records.
